(19) United States
(12) Patent Application Publication
(10) Pub. No.: US 2020/0126114 A1
(43) Pub. Date: Apr. 23, 2020

(54) Blockchain-Based Advertising Delivering and Evaluation Method

(71) Applicants: Ku-Chang Kuo, Taipei City (TW); Che-Ming Hsu, Taoyuan City (TW); Yi-Han Chen, Taipei City (TW); Ku-Lan Kan, Kaohsiung City (TW)

(72) Inventors: Ku-Chang Kuo, Taipei City (TW); Che-Ming Hsu, Taoyuan City (TW); Yi-Han Chen, Taipei City (TW); Ku-Lan Kan, Kaohsiung City (TW)

(21) Appl. No.: 16/162,610

(22) Filed: Oct. 17, 2018

(51) Int. Cl. G06Q 30/02; G06N 99/00

(52) U.S. Cl. CPC G06Q 30/0246; G06N 99/005

(57) ABSTRACT

A blockchain-based advertisement delivering and evaluation method to be applied to a blockchain-based delivering platform providing a user interface to an audience to allow the audience joining the blockchain-based delivering platform is provided and includes the steps of: receiving an advertisement delivering request output from the user interface; generating a smart contract according to the advertisement delivering request; delivering an advertisement to more than one advertising platforms according to the advertisement delivering request while the smart contract is authenticated and executed; and collecting a delivering result and forming a transaction block to be added to the blockchain of the blockchain-based delivering platform.

### FIELD OF THE INVENTION

The present invention relates to a blockchain-based advertisement delivering and evaluation method.

### BACKGROUND OF THE INVENTION

In general, advertisers typically distribute advertisements to the public via certain existing advertisement platforms. Traditional ways of advertising delivery are mainly made through print media, TV, radio broadcasting, and so on.

Due to nowadays changes of user behavior, the advertising through the Internet is trending. Advertisers receive options to pick up users from available social media platform for advertisements such as Facebook, Instagram, and etcetera. Besides, advertisers may also choose to use services provided by SSP (Supply Side Platform) to put their advertisements on web; SSP assists various web media owners hosting their advertisement transactions, so as to offer advertisers distributing the advertisements. Additionally, advertisers may also seek services provided by DSP (Demand Side Platform) for systematically publishing their ads across various web media. DSP allows advertising agencies to target specific media, territory, people, etc., for the advertisers to promote their products or services.

However, no matter how the ads are delivered, the advertising effectiveness can only be obtained through analyses conducted by social media platforms, SSP, or advertisement agencies of DSP. Advertisers have no chance to verify the results as well as to question the authenticity of data, but forced to accept the results provided by advertisement agencies; advertisers has rare negotiation power to against for those of any unrealistic data with questionable.

### SUMMARY OF THE INVENTION

By utilizing the blockchain technology, users are allowed to fully verify the correctness of the data by themselves to make sure the advertising data trustable.

The blockchain-based advertisement delivering and evaluating method of the present invention to be applied, the method includes the following steps:

An advertisement delivering request by advertiser or SSP, this request go through existing real-time bidding process;

This platform generate a smart contract according to the advertisement delivering requirements then deployed on this blockchain;

delivering an advertisement contents to one or more than one existing advertising platforms while the smart contract is authenticated and executed; and

Automatically collecting the result and creating a transaction block which to be logged to this blockchain-based platform.

This blockchain-based platform includes a filtering step then analyzes the delivering result by an artificial intelligent machine-learning approach, which to be filtering out false traffic flow from the delivering result.

The delivering result included click counts, viewing traffic calculation, dwell time, and user information.

User's sensitive information is securely stored in a sidechain of this blockchain platform which will be encrypted by an encryption algorithm.

As can be seen from the above, the following technical features can be achieved by applying the method of the present invention: 1. Solving a problem when advertiser is not able to verify false traffic flow, false clicks or robot-generated fraudulent materials; frauds can be prevented by executing the aforementioned robot filtering and determining process, the user information collection process, and incorporating the data into the non-alterable blockchain platform and can be verified by advertiser or other Ad validation vendors. 2. Providing an incentive mechanism to encourage the audiences being more willing to click on the advertisements. 3. Providing a trustworthy feedback and user information to advertiser to evaluate the result and effectiveness of executing Smart contract.

### BRIEF DESCRIPTION OF THE DRAWINGS

The structure and the technical means adopted by the present invention to achieve the above and other objects can be best understood by referring to the following detailed description of the preferred embodiments and the accompanying drawings.

FIG. 1 is a flowchart illustrating a preferred embodiment of the present invention; and

FIG. 2 is another flowchart illustrating another preferred embodiment of the present invention.

### DETAILED DESCRIPTION OF THE PREFERRED EMBODIMENTS

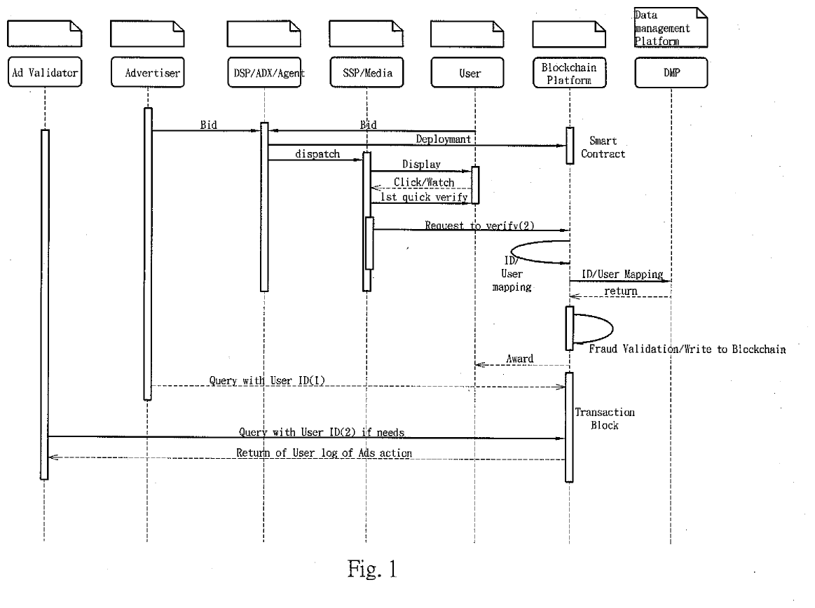

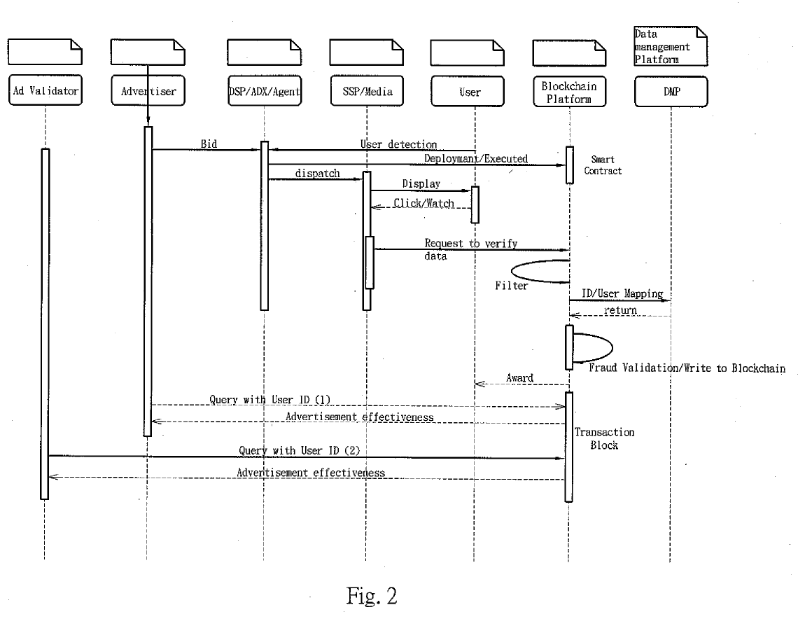

Referring to FIG. 1 and FIG. 2, a blockchain-based evaluation method of the present invention is provided, in which an advertisement is to be delivered to one or more than one Internet advertising platform according to an advertising request from an advertiser through existing way, the advertising platforms generate one or more than one delivering results, and then store the delivering results in the blockchain-based platform. The blockchain-based platform is built under blockchain technology which allows each advertiser and each supplier to access data or verify via the blockchain-based platform, and to jointly maintain the blockchain recording the advertisement delivering requests and the advertising results, in which the blockchain-based advertisement delivering and evaluation method for suppliers and advertisers to operate over the blockchain-based delivering platform includes the following steps:

Receiving an advertisement delivering request: an advertiser publishes an advertisement delivering request via existing channel or, alternatively, a supplier (DSP, agency or media) joins a bidding event and receives the advertisement delivering request from existing user interface, in which an example of the advertisement delivering request is shown below:

The advertiser, KXX company, has planned to deliver advertisements of their newly launched product, and their advertisement delivering request is depicted in a form as below:

1. Price: 1 million USD.

2. Region: Taiwan.

3. Targeted audience: men and women between 12 and 24 years old.

4. Advertising duration: for about 1 month.

5. Expectation: to reach 200 thousands targeted users.

6. Other conditions: audiences clicking on the advertisement may receive a $5 dollar-off coupon per person (or a promo code: “Token”).

Generating a smart contract: the blockchain-based platform generates a smart contract to the supplier in correspondence with the advertisement delivering request, where the smart contract is deployed on blockchain platform, and the smart contract will be added to an existing blockchain after it has been generated, awaiting for execution after being authenticated.

Authenticating the smart contract and execute: the supplier (i.e. an advertisement publisher or integrator) reviews the smart contract and determines whether to join the bidding event or to accept the terms and conditions of the smart contract. While the supplier accepts the terms and conditions of the smart contract, the smart contract will be authenticated and executed automatically. When the smart contract has been executed, relevant advertisements will be delivered to the advertising platform, and meanwhile the payable amount will be calculated based on the contents delivered.

Collecting feedbacks: the blockchain-based platform records a delivery result from the audiences of the delivered advertisement, and the delivery result is logged into the blockchain-based platform to create a transaction block. The delivery result may include but not limited to click count, viewing traffic, dwell time, user information, etc., and the user information may include but not limited to age interval, gender, purchase record, country or region. The user information may relate to a person's sensitive information relative to privacy, such as actual age, address, telephone number, etc., the personal sensitive information is acquired and stored in the sidechain of this blockchain platform, and the sidechain will be encrypted by an encryption manner, where the availability or deletion of the personal sensitive information can be determined by the audience. Accordingly, since the transaction block cannot be altered and has been permanently logged on the blockchain, it is always accessible and trustworthy to the any user. In this way, the advertiser can correctly count how many users have clicked on the new advertisement of the K XX Company within a period of time through the transaction block data, including but not limited to the statistical results of the main region, age distribution and the click count of the users.

The collection of user information can be done in the following ways:

1) In regard with web advertisements, inserting specific Cookies on a website or webpage to record the interactions between the advertisement and the audiences, in which the view count, click count or any other actions that trigger advertisement conversion will be written into the transaction block in the blockchain with a corresponding user ID (UID) utilizing the Cookie of the webpage for further inquiries, in which the records that have been written do not contain any personal private material of the user. Alternatively, records in a third-party auxiliary database can be further incorporated, and when the user data of the audience is written, the third-party auxiliary database can be accessed and read to obtain audience information and accurately identify the specific audiences to be targeted by the advertiser.

2) In regard with in-app advertisements, the device ID number used by the audience or other open information such as the device location while executing the app, the registration region of the audience, and any relevant information of the audience/user, can be collected by the app itself or by using an SDK of the app. The aforementioned device can be a mobile phone, a tablet or a computer, etc., the device location can be obtained in conjunction with base stations or by Wi-Fi positioning manners acquiring LBS (location-based service) location data;

In order to avoid that the delivery result may contain false traffic generated by robots, a filtering step may be further included to find fraudulent false traffic by machine learning.

This filtering step can analyze whether the data contains false traffic based on analyses of the following behaviors:

1) The filtering step determines whether the click on the advertisement in the webpage was made by a robot according to the cursor movement recorded in a webpage embedded program;

2) The filtering step can also use a Turing test method to determine whether a robot made the click on the advertisement by letting the audience answer a question appeared at the time the advertisement has been clicked or viewed.

3) The filtering step can determine whether the clicks on the advertisement were made from the same device according to an audience device ID and/or a device Internet IP recorded in the Cookies of the webpage, thereby determining and filtering out the false traffic flow created by robot programs once any abnormal click appears.

When the foregoing filtering step detects a robot click, such record will not be written into the transaction block of this blockchain. Practically, the determining mechanism and behavior of the filtering steps can be done by designating, assign to specific or a part of compute node in blockchain platform in order to complete the verification. If it has been verified that the advertisement click was not made by a robot which generates false traffic flow, the block producer may then deem as a valid click and thus to directly write into the transaction block of the blockchain. If it has been determined as a robot behavior, or any manner that generates false traffic flow, the audience device ID, the device Internet IP will be listed in a banned list to prevent interruption from the robot again upon delivery of the advertisement.

In order to enhance the willingness of the audiences to click on advertisements, an incentive mechanism can be incorporated into the step of authenticating and executing the smart contract, in which the incentives offered by the advertiser can be received by the user after a valid view or click on the advertisement according to the smart contract. The incentives may be but not limited to an amount of money/currency or virtual money/currency, discount coupon, promo code, or a token . . . etc, so as to encourage the audiences clicking the advertisement generating valid traffic flow. In a practical instance, a dwell time can be recorded by the webpage embedded program, and, for instance, 0.5 token can be distributed to the audience for each 5-minute dwell time; alternatively, the audience may obtain 5 tokens when he/she complete viewing the advertisement or downloading and installing a Software; what is more, the audience may receive 10 tokens in an instance that the audience purchased relevant products because of viewing such advertisement.

Furthermore, the aforementioned token mechanism can be exchanged on online exchange platforms or between users. If the user purchases corresponding products, the tokens collected may offer equivalent discounts, thereby replacing some usages on paper/electronic coupons, and enhancing the user's willingness of making clicks on the advertisements, and watching the advertisements to increase the actual conversion rate according to the advertisement clicks.

Moreover, the Maximum awards can be set for the tokens distributed to each user, for instance, each valid user could only meet the condition once or twice to get incentives. This upper limit can be included in the smart contract to avoid encountering technical issues such as repeating registration or automated robot attacks that might consume the advertiser's budget rapidly, and will allow real users with actual willingness have time to meet the condition.

In addition, the incentive mechanism may also be applied to encourage users authenticating and providing their personal data for operational use of the platform. The blockchain-based delivering platform may distribute an amount of money/currency, virtual money/currency, credit, token . . . etc to the user who agrees to authorize the availability of their personal data, so as to encourage users to be more willing to use this platform and to watch advertisements, making a positive impact on business operations.

As can be seen from the foregoing embodiments, the following technical features can be achieved by applying the method of the present invention:

1. Solving a problem that the advertiser is not able to identify false traffic flow, false clicks or robot-generated fraudulent materials. Frauds may be greatly prevented by processing through the aforementioned robot filtering and determining process, the user information collection process, and incorporating the data into this non-alterable blockchain platform.

2. Providing an incentive mechanism to make the audiences being more willing to click on the advertisements.

3. Providing a trustworthy feedback and user information to advertiser to evaluate the result and effectiveness of executing Smart contract and vice versa, the advertiser can proactively request the related authenticated data from the original smart contract or pay in addition data for their further offline business evaluation & verification needs.

While various embodiment(s) have been described above, it should be understand that they have been presented by way of examples only, and should not be construed as limiting the inventive concept. Thus, the breadth and scope of preferred embodiment should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration. The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A blockchain-based advertisement delivering and evaluation, the method comprising:
generating a smart contract according to a advertisement delivering request;
authenticating and executing a smart contract;
identifying and filtering collected data then logging into a transaction block on a blockchain platform; and
providing an immutability data accessible for advertising effectiveness when evaluation is needed.

2. The method as claimed in claim 1, further comprising:
receiving the advertisement delivering request, and generating the smart contract, wherein the smart contract is stored on the blockchain platform.

3. The method as claimed in claim 1, further comprising:
an identifying and collecting mechanism, analyzing the delivering result by an artificial intelligent machine-learning approach, and filtering out false or abnormal traffic flow from the delivering result, wherein the delivering result comprises click count, viewing traffic, dwell time, user information, or any combination thereof.

4. The method as claimed in claim 1, wherein the step of authenticating and executing the smart contract further comprises an incentive mechanism automatically delivering to a user when the user has effectively completed viewing or clicking the advertisement.

5. The method as claimed in claim 1, wherein a personal sensitive information of the user information is stored in a sidechain of the blockchain platform and is encrypted by an encryption manner.

6. The method as claimed in claim 1, further comprising:
a reviewing and feedback mechanism for adviser to effectively validate the delivering result.
